(19) United States
(12) Patent Application Publication
(10) Pub. No.: US 2003/0073423 A1
(43) Pub. Date: Apr. 17, 2003

(54) Receiver of mobile communication terminal

(75) Inventor: Seung-Ki Cho, Seoul (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/266,678

(22) Filed: Oct. 8, 2002

(30) Foreign Application Priority Data
Oct. 15, 2001 (KR) 63517/2001

(51) Int. Cl. H04B 1/26

(52) U.S. Cl. 455/324; 455/323; 455/318

(57) ABSTRACT

A receiver of a mobile communication terminal comprising a down-converter for down-converting a signal received to the receiver into an intermediate frequency signal, a first received signal path for providing the received signal to the down-converter, the first received signal path including a low-noise amplifier for low-noise amplifying the received signal, and a band pass filter for band pass filtering an output signal from the low-noise amplifier to pass only signal components within a reception band of the mobile communication terminal, a second received signal path for providing the received signal directly to the down-converter, and a controller for providing the received signal to the down-converter through one of the first received signal path and second received signal path on the basis of first and second received signal power threshold values. The first and second threshold values are set in consideration of losses of the low-noise amplifier and band pass filter.

### PRIORITY

This application claims priority to an application entitled “RECEIVER OF MOBILE COMMUNICATION TERMINAL”, filed in the Korean Industrial Property Office on Oct. 15, 2001 and assigned Serial No. 2001-63517, the contents of which are hereby incorporated by reference.

### BACKGROUND OF THE INVENTION

1. Field of the Invention

The present invention relates to a mobile communication terminal, and more particularly to a receiver of a mobile communication terminal.

2. Description of the Related Art

Mobile communication terminals generally have receivers for processing signals received through antennas as illustrated in FIG. 1. FIG. 1 illustrates a construction of a conventional receiver of one such mobile communication terminal. As illustrated in FIG. 1, a signal received through an antenna 101 is applied to a duplexer 102, which separates a signal to be transmitted and a received signal from each other. The duplexer 102 extracts only signal components within a reception band of the mobile communication terminal from the signal received through the antenna 101 and applies the extracted signal components to a low-noise amplifier (referred to hereinafter as “LNA”) 103. The LNA 103 amplifies a low level of the signal received through the antenna 101 and passed through the duplexer 102 to an optimum level. A band pass filter 104 extracts only the signal components within the reception band from an output signal from the LNA 103 and applies the extracted signal components to a mixer 105 for their frequency down-conversion into an intermediate frequency. The mixer 105 mixes an output signal from the band pass filter 104 with a local oscillation signal from a local oscillator 106 to down-convert its frequency into an intermediate frequency corresponding to an associated channel. The signal whose frequency was down-converted by the mixer 105 is amplified by a predetermined level by an intermediate frequency amplifier 107, filtered by an intermediate frequency filter 108 and then applied to an intermediate frequency automatic gain control amplifier (referred to hereinafter as “IF AGC AMP”) 109. The IF AGC AMP 109 amplifies or attenuates an output signal from the intermediate frequency filter 108 to an appropriate level in response to a reception gain adjustment signal RX_AGC_ADJ from a baseband processor 111 and outputs the amplified or attenuated signal to a demodulator 110. The demodulator 110 demodulates the output signal from the IF AGC AMP 109. In FIG. 1, the reference numeral 112, not described, denotes a power amplifier which is one of constituent elements in a transmitter of the mobile communication terminal.

In FIG. 1, the output signal from the IF AGC AMP 109, provided to the demodulator 110, must always be maintained at a constant level. To this end, the baseband processor 111 provides the reception gain adjustment signal RX_AGC_ADJ to the IF AGC AMP 109. When an input power level (i.e., the output level of the IF AGC AMP 109) is higher, the baseband processor 111 lowers a voltage level of the reception gain adjustment signal RX_AGC_ADJ so that the IF AGC AMP 109 can have a negative (−) gain. On the other hand, when the input power level (i.e., the output level of the IF AGC AMP 109) is lower, the baseband processor 111 raises the voltage level of the reception gain adjustment signal RX_AGC_ADJ so that the IF AGC AMP 109 can have a positive (+) gain.

As stated above, in the mobile communication terminal, a signal is received through the antenna and then restored to its original state through the receiver. On the other hand, the signal received through the antenna may contain interference signal components (typically called “jammers”) in addition to the original signal component. In this case, if the received signal's strength is too high, the mobile communication terminal receiver restores the original signal component with a signal distortion appearing. Namely, the system is degraded in linearity.

If the received signal is degraded in reception sensitivity due to signal components other than the original signal component, or jammers, for example, an LNA with a switching structure may be used to increase the system linearity.

FIG. 2 illustrates a construction of a conventional amplifier control unit including an LNA with a switching structure for improving linearity. Some parts in FIG. 2 are substantially the same as those in FIG. 1 and thus denoted by the same reference numerals. As illustrated in FIG. 2, the conventional amplifier control unit includes an LNA 103, a switch 204 connected between input and output terminals of the LNA 103, and a baseband processor 111 for controlling the switch 204.

It is common that a received signal improves in signal sensitivity (for example, signal to noise ratio: Eb/No) as it becomes higher in power level. However, if the received signal contains jammers, the reception sensitivity thereof may become lower than a predetermined threshold value under the condition that the power level thereof becomes higher than a predetermined reference value. In this case, the baseband processor 111 turns on the switch 204 to improve the system linearity. At this time, the LNA 103 is disabled under the control of the baseband processor 111. As a result, the received signal is applied to a band pass filter 104 directly, not via the LNA 103, so that it is secured in linearity.

In the above-mentioned linearity improvement method, however, the received signal is subject to no loss by the LNA 103, but its noise figure is degraded by a total of 6 dB, namely, about 3 dB, which is a loss of the switch 204 when being turned on, and about 3 dB which is a loss of the band pass filter 104 at the subsequent stage of the LNA 103. This signifies that the reception sensitivity is degraded by such a degree. One approach to this problem is to make the linearity of a mixer very good. This method, however, results in an increase in the amount of current being consumed.

### SUMMARY OF THE INVENTION

Therefore, the present invention has been designed in view of the above problems, and it is an object of the present invention to provide a receiver of a mobile communication terminal, which is capable of improving a noise figure to control a received signal over a wider range.

It is another object of the present invention to provide a receiver of a mobile communication terminal, which is capable of optimizing a signal reception state within a shorter period of time.

In accordance with one aspect of the present invention, the above and other objects can be accomplished by a receiver of a mobile communication terminal, comprising: a down-converter for down-converting a signal received by the receiver into an intermediate frequency signal; a first received signal path for providing the received signal to the down-converter, the first received signal path including a low-noise amplifier for low-noise amplifying the received signal, and a band pass filter for band pass filtering an output signal from the low-noise amplifier to pass only signal components within a reception band of the mobile communication terminal; a second received signal path for providing the received signal directly to the down-converter; and a controller for providing the received signal to the down-converter through one of the first received signal path and second received signal path on the basis of first and second received signal power threshold values, the first and second threshold values being set in consideration of losses of the low-noise amplifier and the band pass filter.

In accordance with another aspect of the present invention, there is provided a receiver of a mobile communication terminal, comprising: a low-noise amplifier for low-noise amplifying a signal received by the receiver; a band pass filter connected to the low-noise amplifier, the band pass filter band pass filtering an output signal from the low-noise amplifier to pass only signal components within a reception band of the mobile communication terminal; a down-converter for down-converting the received signal into an intermediate frequency signal; a first switch positioned at a preceding stage of the low-noise amplifier for receiving the received signal as its input; a second switch positioned between an output terminal of the band pass filter and an input terminal of the down-converter; and a controller for controlling the first and second switches on the basis of first and second received signal power threshold values to provide the received signal through the low-noise amplifier and band pass filter to the down-converter or directly to the down-converter, the first and second threshold values being set in consideration of losses of the low-noise amplifier and the band pass filter.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a block diagram illustrating a construction of a conventional receiver of a mobile communication terminal;

FIG. 2 is a block diagram illustrating a construction of a conventional amplifier control unit including a low-noise amplifier (LNA) with a switching structure for improving linearity;

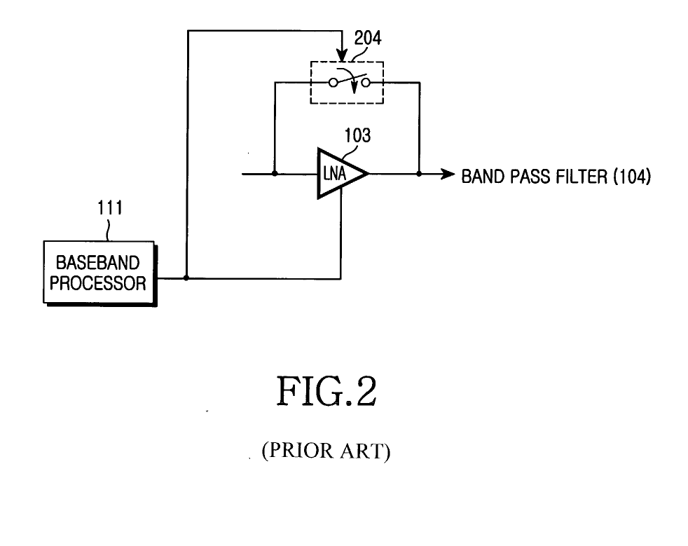

FIG. 3 is a block diagram illustrating a construction of a receiver of a mobile communication terminal with improved linearity and noise figure in accordance with a preferred embodiment of the present invention;

FIG. 4 is a detailed circuit diagram of the receiver illustrated in FIG. 3; and

FIG. 5 is a graph showing a hysteresis characteristic curve between gain adjustment code values and received signal power levels in accordance with the preferred embodiment of the present invention.

### DETAILED DESCRIPTION OF THE PREFERRED EMBODIMENTS

Preferred embodiments of the present invention will be described in detail herein below with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

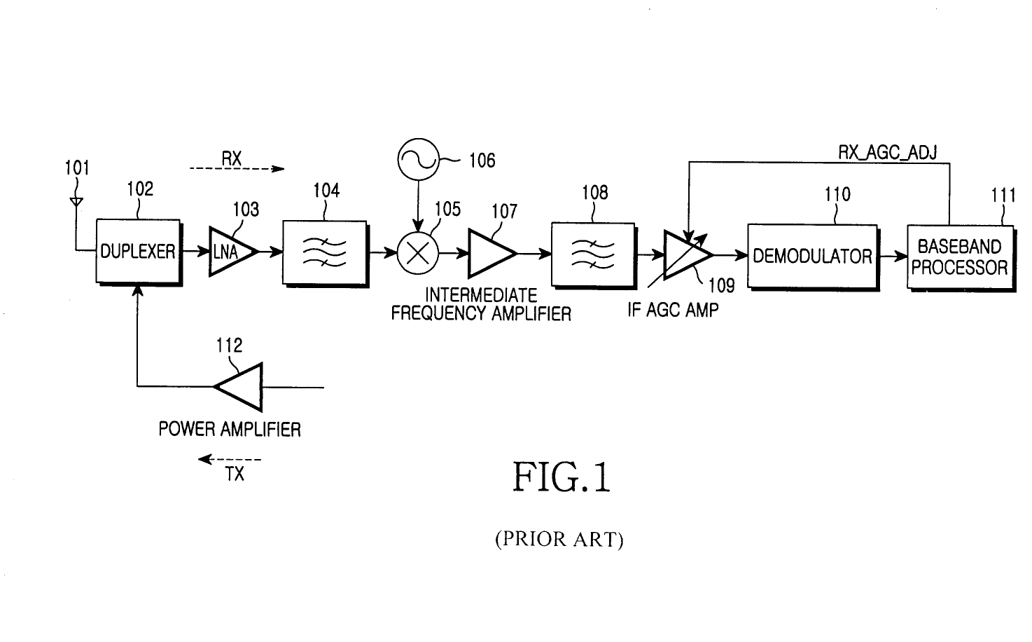

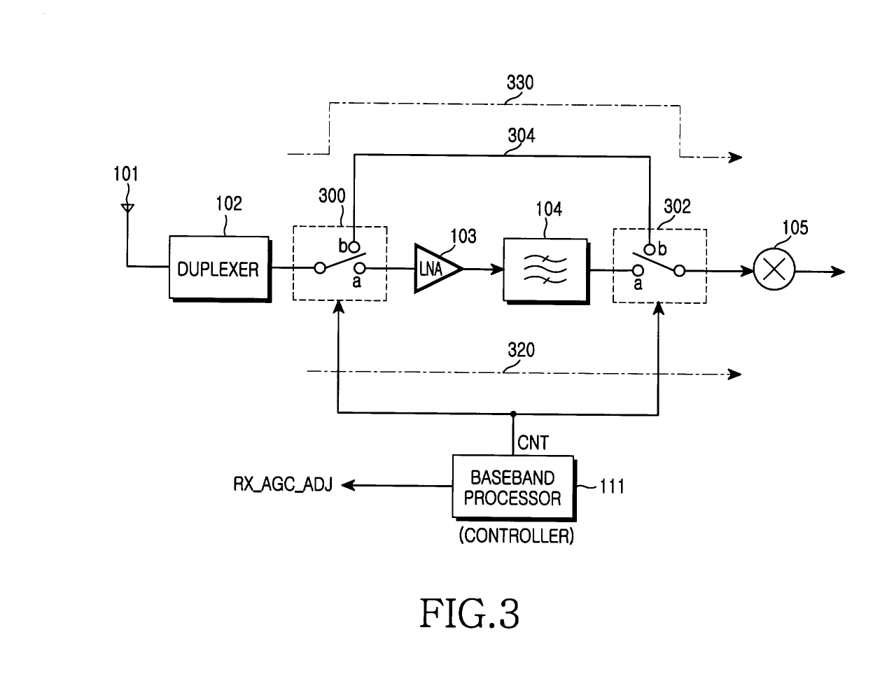

With reference to FIG. 3, a construction of a receiver of a mobile communication terminal with improved linearity and noise figure in accordance with a preferred embodiment of the present invention is illustrated. Some elements of FIG. 3 are substantially the same as those illustrated in FIG. 1 and thus denoted by the same reference numerals.

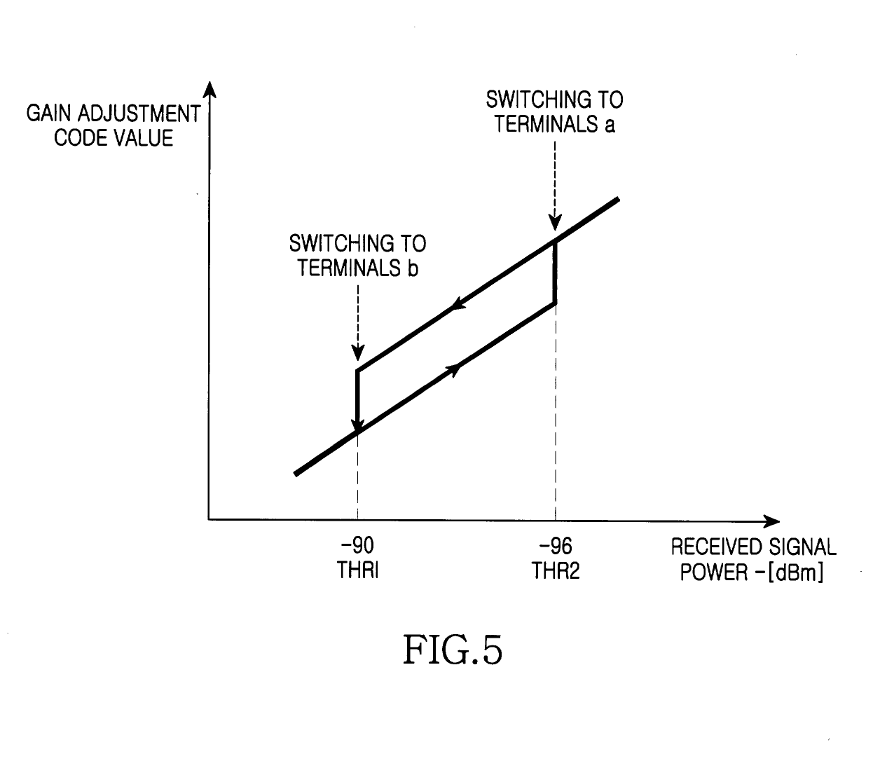

As illustrated in FIG. 3, the mobile communication terminal receiver comprises a first received signal path 320, a second received signal path 330, and a baseband processor 111 for performing a control operation to provide a received signal to a down-converter, or a mixer, 105 through one of the first received signal path 320 and the second received signal path 330. In the first received signal path 320, a signal received through an antenna 101 and a duplexer 102 is provided to the down-converter or mixer 105 via a low-noise amplifier (LNA) 103 and a band pass filter 104. The LNA 103 acts to low-noise amplify the received signal, and the band pass filter 104 acts to band pass filter an output signal from the LNA 103 to pass only signal components within a reception band of the mobile communication terminal. In the second received signal path 330, the signal received through the antenna 101 and duplexer 102 is provided directly to the down-converter or mixer 105. In the preferred embodiment of the present invention, the baseband processor 111 acts as a controller for providing the received signal to the down-converter or mixer 105 through one of the first received signal path 320 and the second received signal path 330 on the basis of first and second received signal power threshold values (i.e., THR1 and THR2 in FIG. 5 to be described later) set in consideration of losses of the LNA 103 and band pass filter 104. The mixer 105 acts to down-convert the received signal provided through one of the first and second received signal paths 320 and 330 into an intermediate frequency signal.

To provide the first and second received signal paths 320 and 330, a first switch 300 is positioned at the preceding stage of the LNA 103, and a second switch 302 is positioned between the band pass filter 104 and the down-converter or mixer 105. The first switch 300 has its input terminal connected to an output terminal of the duplexer 102, its first output terminal a connected to an input terminal of the LNA 103 and its second output terminal b connected to a bypass signal line 304. The second switch 302 has its output terminal connected to an input terminal of the mixer 105, its first input terminal a connected to an output terminal of the band pass filter 104 and its second input terminal b connected to the bypass signal line 304. The controller or baseband processor 111 generates a control signal CNT for the control of the first and second switches 300 and 302 on the basis of the first and second received signal power threshold values set in consideration of losses of the LNA 103 and band pass filter 104. As a result, under the control of the baseband processor 111, an output signal from the duplexer 102 is provided to the down-converter or mixer 105 via the LNA 103 and band pass filter 104, or directly to the mixer 105.

It is prescribed in IS-95, JSO-008 that a dynamic range, which is one of performance parameters of receivers of code division multiple access (CDMA) and personal communication service (PCS) mobile communication terminals, is −104˜−25 dBm/BW. In this connection, the present mobile communication terminal receiver has a wide dynamic range of 79 dB. The IF AGC AMP 109 of FIG. 1 has a gain adjustment range of +45 dB˜−45 dB in order to maintain a voltage applied to the demodulator 110 at a constant level over the entire dynamic range of the receiver. If an input signal of a high power level is applied to the receiver, the IF AGC AMP 109 adjusts the gain of the input signal up to −45 dB at maximum under the control of the baseband processor 111. On the other hand, if an input signal of a low power level is applied to the receiver, the IF AGC AMP 109 adjusts the gain of the input signal up to +45 dB at maximum under the control of the baseband processor 111. Received signal power levels and gain adjustment code values for control of the IF AGC AMP 109 are in inverse proportion to each other, and the gain adjustment code values are predetermined based on the received signal power levels.

FIG. 5 is a graph showing a hysteresis characteristic curve between gain adjustment code values and received signal power levels in accordance with the preferred embodiment of the present invention. As seen from this graph, the gain adjustment code values and the received signal power levels are in inverse proportion to each other. The hysteresis characteristic curve as shown in FIG. 5 appears as the first and second switches 300 and 302 are operated under the control of the baseband processor 111 according to the present embodiment. Because the hysteresis characteristic curve as shown in FIG. 5 appears on the basis of the first and second received signal power threshold values THR1 and THR2 set in consideration of both losses of the LNA 103 and band pass filter 104, it has a larger margin width than a conventional one when only the loss of the LNA 103 is considered. In the preferred embodiment of the present invention, the first and second received signal power threshold values THR1 and THR2 are set in consideration of a predetermined received signal reception sensitivity threshold value, for example, a signal to noise ratio Eb/No of 4 dB along with the losses of the LNA 103 and band pass filter 104.

In the present embodiment, if power of a received signal gradually increases from a low level and then arrives at the first received signal power threshold value THR1, that is, −90 dBm, the received signal is provided to the mixer 105 over the bypass signal line 304, not via the LNA 103 and band pass filter 104, under the control of the controller or baseband processor 111. In other words, the received signal improves in reception sensitivity as it becomes higher in power level. In this regard, in this case, it is not necessary to amplify the received signal using the LNA 103. Thus, even though jammers are contained in the received signal, the influence thereof is reduced as much as the degree of amplification by the LNA 103. Moreover, the received signal is compensated for loss by the level of loss upon passage through the LNA 103 and band pass filter 104. In this case, because the LNA 103 is not operated, the band pass filter 104 need not be operated. On the other hand, if power of a received signal gradually decreases from a high level and then arrives at the second received signal power threshold value THR2, that is, −96 dBm, the received signal is provided to the mixer 105 via the LNA 103 and band pass filter 104 under the control of the controller or baseband processor 111. In other words, the received signal becomes worse in reception sensitivity as it becomes lower than −96 dBm in power level. Also in this case, jammers have a smaller effect on the received signal. For these reasons, it is preferred that the received signal is passed through the LNA 103 and band pass filter 104.

Now, the operation of the mobile communication terminal receiver according to the preferred embodiment of the present invention will be described in detail with reference to FIGS. 3 and 5.

First, if power of a received signal gradually increases from a low level and then arrives at the first received signal power threshold value THR1, which is higher than the second received signal power threshold value THR2, the baseband processor 111 applies the switch control signal CNT of logic “L” to the first and second switches 300 and 302 such that the input terminal of the first switch 300 is connected to the second output terminal b thereof and the output terminal of the second switch 302 is connected to the second input terminal b thereof. As a result, the received signal is transferred to the mixer 105 via the duplexer 102, the second output terminal b of the first switch 300, the bypass signal line 304, and the second input terminal b of the second switch 302. Namely, the output signal from the duplexer 102 is applied to the mixer 105 directly, not via the LNA 103 and band pass filter 104. Consequently, the signal applied to the mixer 105 can be improved in linearity as much as the degree of amplification by the LNA 103. Furthermore, because the switches 300 and 302 are interconnected via the bypass signal line 304, not via the LNA 103 and band pass filter 104, the noise figure can be improved by the sum of the loss of the LNA 103 and the loss of the band pass filter 104 as compared with a conventional one.

Next, if power of a received signal gradually decreases from a high level and then arrives at the second received signal power threshold value THR2, which is lower than the first received signal power threshold value THR1, the baseband processor 111 applies the switch control signal CNT of logic “H” to the first and second switches 300 and 302 such that the input terminal of the first switch 300 is connected to the first output terminal a thereof and the output terminal of the second switch 302 is connected to the first input terminal a thereof. As a result, the received signal is transferred to the mixer 105 via the duplexer 102, the first output terminal a of the first switch 300, the LNA 103, the band pass filter 104 and the first input terminal a of the second switch 302. Namely, the output signal from the duplexer 102 is applied to the mixer 105 via the LNA 103 and band pass filter 104.

The larger the difference between the first received signal power threshold value THR1 for switching of the first and second switches 300 and 302 to the terminals b and the second received signal power threshold value THR2 for switching of the first and second switches 300 and 302 to the terminals a, the better the system stability. As the noise figure becomes better, the reception sensitivity increases proportionally, thereby enabling the second received signal power threshold value THR2 to set to a lower value in proportion thereto. According to the present invention, the receiver can control the restoration of a signal received through the antenna within a short period of time on the basis of only a power level of the received signal, without analyzing jammer values. Therefore, the receiver can maintain an optimal reception state.

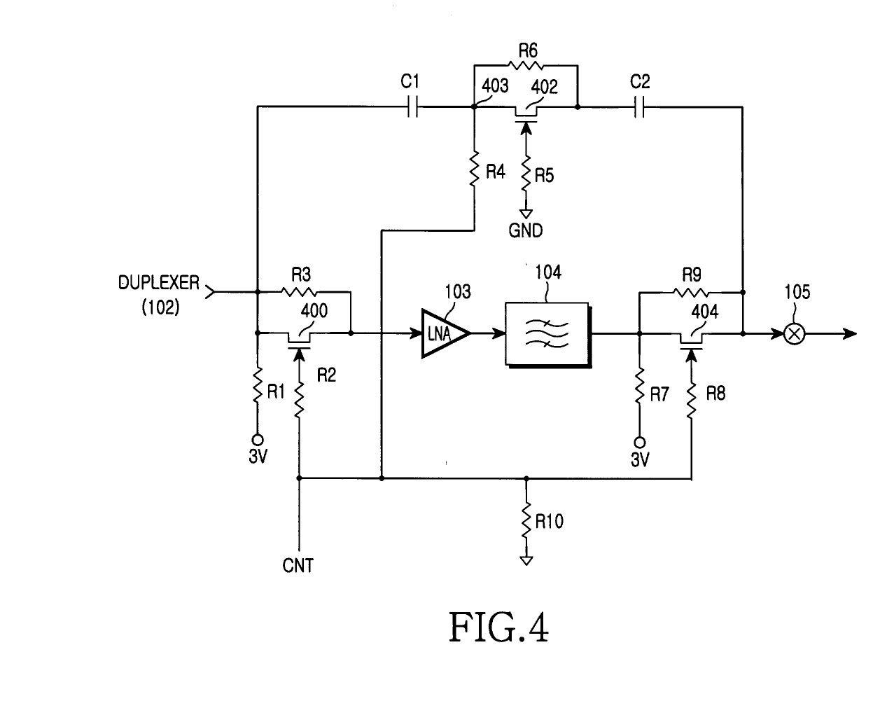

FIG. 4 is a detailed circuit diagram of the receiver illustrated in FIG. 3. With reference to FIG. 4, if the power of a received signal gradually increases from a low level and then arrives at the predetermined threshold value THR1, the baseband processor 111 generates the switch control signal CNT of logic “L”, namely, 0 V. This switch control signal CNT of 0 V is applied to a gate of an N-channel transistor 400 via a resistor R2, and a gate of an N-channel transistor 404 via a resistor R8, respectively. As a result, the N-channel transistors 400 and 404 become nonconductive. The switch control signal CNT of 0 V is also applied via a resistor R4 to a drain 403 of an N-channel transistor 402, a gate of which is grounded. As a result, the N-channel transistor 402 is turned on. Consequently, the output signal from the duplexer 102 is applied directly to the mixer 105 via a capacitor C1, the N-channel transistor 402, and a capacitor C2 (forming the bypass signal line 304 of FIG. 3), not via the LNA 103 and band pass filter 104.

On the other hand, if power of a received signal gradually decreases from a high level and then arrives at the predetermined threshold value THR2, the baseband processor 111 generates the switch control signal CNT of logic “H”, namely, 3 V. This switch control signal CNT of 3 V is applied to the gate of the N-channel transistor 400 via the resistor R2, and the gate of the N-channel transistor 404 via the resistor R8, respectively. As a result, the N-channel transistors 400 and 404 conduct. The switch control signal CNT of 3 V is also applied via the resistor R4 to the drain 403 of the N-channel transistor 402 whose gate is grounded. As a result, the N-channel transistor 402 becomes nonconductive. Consequently, the output signal from the duplexer 102 is applied to the mixer 105 via the LNA 103 and band pass filter 104.

As apparent from the above description, the present invention provides a receiver of a mobile communication terminal, which is capable of controlling a restoration of a received signal within a short period of time on a basis of only a power level of the received signal, so as to maintain an optimal reception state. Further, the receiver is simple in circuit construction and is improved in noise figure, so that it can control the received signal over a wider range. This wider control range results in an increase in control reliability.

Although preferred embodiments of the present invention have been disclosed for illustrative purposes, those skilled in the art will appreciate that various modifications, additions and, substitutions are possible, without departing from the scope and spirit of the invention as disclosed in the accompanying claims.

What is claimed is:

1. A receiver of a mobile communication terminal, comprising:
a down-converter for down-converting a signal received by said receiver into an intermediate frequency signal;
a first received signal path for providing said received signal to said down-converter, said first received signal path including a low-noise amplifier for low-noise amplifying said received signal, and a band pass filter for band pass filtering an output signal from said low-noise amplifier to pass only signal components within a reception band of said mobile communication terminal;
a second received signal path for providing said received signal directly to said down-converter; and
a controller for providing said received signal to said down-converter through one of said first received signal path and said second received signal path on a basis of first and second received signal power threshold values, said first and second threshold values being set in consideration of losses of said low-noise amplifier and band pass filter.

2. A receiver of a mobile communication terminal, comprising:
a low-noise amplifier for low-noise amplifying a signal received by said receiver;
a band pass filter connected to said low-noise amplifier, said band pass filter band pass filtering an output signal from said low-noise amplifier to pass only signal components within a reception band of said mobile communication terminal;
a down-converter for down-converting said received signal into an intermediate frequency signal;
a first switch positioned at a preceding stage of said low-noise amplifier for receiving said received signal as its input;
a second switch positioned between an output terminal of said band pass filter and an input terminal of said down-converter; and
a controller for controlling said first and second switches on a basis of first and second received signal power threshold values to provide said received signal through said low-noise amplifier and band pass filter to said down-converter or directly to said down-converter, said first and second threshold values being set in consideration of losses of said low-noise amplifier and band pass filter.
